(19) United States
(12) Patent Application Publication
(10) Pub. No.: US 2026/0270931 A1
(43) Pub. Date: Sep. 10, 2026

(54) METHODS FOR ACTIVATION AND DEACTIVATION OF SL PRS

(71) Applicant: Telefonaktiebolaget LM Ericsson (publ), Stockholm (SE)

(72) Inventors: Siva Muruganathan, Stittsville (CA); Florent Munier, Västra Frölunda (SE); Peter Hammarberg, Mölndal (SE); Gustav Lindmark, Linköping (SE)

(21) Appl. No.: 19/103,216

(22) PCT Filed: Aug. 14, 2023
(86) PCT No.: PCT/IB2023/058183

§ 371 Date: Feb. 11, 2025

Related U.S. Application Data
(60) Provisional application No. 63/397,639, filed on Aug. 12, 2022.

(51) Int. Cl. H04W 64/00; H04W 72/044; H04W 72/232

(52) U.S. Cl. CPC H04W 64/00; H04W 72/044; H04W 72/232

(57) ABSTRACT

Systems and methods for activation and deactivation of Sidelink (SL) Positioning Reference Signal (PRS) are provided. In some embodiments, a method performed by a UE includes: receiving control signaling for triggering SL PRS, where the control signaling includes: a resource allocation in time and/or frequency domain; a comb and/or repetition factor associated with SL PRS; an identifier for the SL PRS; an offset between receiving the control signal and when the SL PRS will be transmitted or received/measured; and an indicator indicating whether the SL PRS is for transmission or reception/measurement by the UE. In this way, some embodiments enable semi-persistent or aperiodic SL PRSs to be activated/deactivated or triggered on when SL positioning measurements are needed. Hence, these embodiments allow interference caused by SL PRS to other UEs to be reduced. In addition, the proposed solutions also reduce the SL overhead when compared to a periodic SL PRS transmission.

### RELATED APPLICATIONS

This application claims the benefit of provisional patent application Ser. No. 63/397,639, filed Aug. 12, 2022, the disclosure of which is hereby incorporated herein by reference in its entirety.

### TECHNICAL FIELD

The present disclosure relates generally to activating reference signals.

### BACKGROUND

In the upcoming release 18 work in 3GPP, solutions for sidelink (SL) ranging and positioning will be studied and standardized, as outlined in the study item description (see RP-213561).

Previous standardization work for SL in 3GPP has focused on the communication aspects. From a positioning perspective, in previous releases, the network has been catering for the need of positioning for the cellular system. Exploiting SL measurements in device positioning is therefore a new paradigm for positioning using 3GPP technology.

### NR Currently Supports Below RAT Dependent Positioning Methods:

### DL-TDOA:

The DL TDOA positioning method makes use of the DL RSTD (and optionally DL PRS RSRP) of downlink signals received from multiple TPs, at the UE. The UE measures the DL RSTD (and optionally DL PRS RSRP) of the received signals using assistance data received from the positioning server, and the resulting measurements are used along with other configuration information to locate the UE in relation to the neighboring TPs.

Multi-RTT: The Multi-RTT positioning method makes use of the UE Rx-Tx measurements and DL PRS RSRP of downlink signals received from multiple TRPs, measured by the UE and the measured gNB Rx-Tx measurements and UL SRS-RSRP at multiple TRPs of uplink signals transmitted from UE.

### UL-TDOA:

The UL TDOA positioning method makes use of the UL TDOA (and optionally UL SRS-RSRP) at multiple RPs of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

### DL-AoD:

The DL AoD positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

### UL-AoA:

The UL AoA positioning method makes use of the measured azimuth and zenith of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

### NR-ECID:

NR Enhanced Cell ID (NR E-CID) positioning refers to techniques which use additional UE measurements and/or NR radio resource and other measurements to improve the UE location estimate.

### The Positioning Modes can be Categorized in Below Three Areas:

UE-Assisted: The UE performs measurements with or without assistance from the network and sends these measurements to the E-SMLC where the position calculation may take place.
UE-Based: The UE performs measurements and calculates its own position with assistance from the network.
Standalone: The UE performs measurements and calculates its own without network assistance.

### REFERENCE SIGNALS IN NR FOR POSITIONING

In NR Rel. 16, the following reference signals were introduced for positioning purposes:

A new DownLink (DL) reference signal, the NR DL PRS (Positioning Reference Signal) was specified. The main benefit of this signal in relation to the LTE DL PRS is the increased bandwidth, configurable from 24 to 272 resource blocks (RBs), which gives a big improvement in time of arrival (TOA) accuracy. The NR DL PRS can be configured with a comb factor of 2, 4, 6 or 12. Comb-12 allows for twice as many orthogonal signals as the comb-6 LTE PRS. Beam sweeping is also supported on NR DL PRS in Rel-16.

A new UL reference signal, based on the NR UL Sounding Reference Signal (SRS) was introduced and called “SRS for positioning”. The Rel. 16 NR SRS for positioning allows for a longer signal, up to 12 symbols (compared to 4 symbols in Rel. 15 SRS), and a flexible position in the slot (only the last six symbols of the slot can be used in Rel. 15 SRS). It also allows for a staggered comb resource element (RE) pattern for improved TOA measurement range and for more orthogonal signals based on comb offsets (comb 2, 4 and 8) and cyclic shifts. The use of cyclic shifts longer than the Orthogonal Frequency Division Multiplexed (OFDM) symbol divided by the comb factor is, however, not supported by Rel. 16 despite that this is the main advantage of comb-staggering at least in indoor scenarios. Power control based on neighbor cell Synchronization Signal Block (SSB)/DL PRS is supported as well as spatial Quasi-CoLocation (QCL) relations towards a Channel State Information Reference Signal (CSI-RS), an SSB, a DL PRS, or another Sounding Reference Signal (SRS).

### Sidelink Transmissions in NR

3GPP specified the LTE D2D (device-to-device) technology, also known as ProSe (Proximity Services) in the Release 12 and 13 of LTE. Later in Rel. 14 and 15, LTE V2X related enhancements targeting the specific characteristics of vehicular communications were specified. 3GPP started a new work item (WI) in August 2018 within the scope of Rel. 16 to develop a new radio (NR) version of V2X communications. The NR V2X mainly targets advanced V2X services, which can be categorized into four use case groups: vehicles platooning, extended sensors, advanced driving and remote driving. The advanced V2X services would require enhancements of the NR system and a new NR sidelink framework could help to meet the stringent requirements in terms of latency and reliability. NR V2X system also expects to have higher system capacity and better coverage and to allow for an easy extension to support the future development of further advanced V2X services and other services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that are only of interest to the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between the UEs (user equipment) and the NW (network), including support for standalone, network-less operation.

In 3GPP Rel. 17, discussions took place and National Security and Public Safety, NSPS, is considered to be one important use cases, which can benefit from the already developed NR sidelink features in Rel. 16. Therefore, it is most likely that 3GPP will specify enhancements related to NSPS use case taking NR Rel. 16 sidelink as a baseline. Besides, in some scenarios NSPS services need to operate with partial or w/o NW coverage, such as indoor firefighting, forest firefighting, earthquake rescue, sea rescue, etc. where the infrastructure is (partially) destroyed or not available, therefore, coverage extension is a crucial enabler for NSPS, for both NSPS services communicated between UE and cellular NW and that communicated between UEs over sidelink. In Rel. 17, a SID on NR sidelink relay (RP-193253) was launched which aims to further explore coverage extension for sidelink-based communication, including both UE to NW relay for cellular coverage extension and UE to UE relay for sidelink coverage extension. Now the work has proceeded to normative phase and in the WID (New SID on Study on expanded and improved NR positioning, 3GPP TSG RAN Meeting #94e, December 2021) only UE to NW relay is considered.

In the discussions and planning for NR Rel. 18, sidelink based ranging and positioning has been agreed for standardization. With ranging, it in general implies that both distance and angle information about the wireless link between two devices is derived. Distance ranging is today available in other standards, e.g., IEEE 802.4z, where in general, a signal exchange is taking place between two devices allowing the round-trip-time (RTT) to be calculated.

### Different SL Scenarios

Sidelink communication can occur in three different scenarios as depicted in FIG. 1: In-Coverage (IC); Out-of-Coverage (OoC); and Partial Coverage (PC).

### SUMMARY

Systems and methods for activation and deactivation of Sidelink (SL) Positioning Reference Signal (PRS) are provided. In some embodiments, a method performed by a UE for triggering SL PRS includes: receiving control signaling for triggering SL PRS, where the control signaling includes one or more of: a resource allocation in time domain; a resource allocation in frequency domain; a comb factor associated with SL PRS; a repetition factor associated with SL PRS; an identifier for the SL PRS; an offset between the time in which the control signal is received and the time in which SL PRS will be transmitted or received/measured; and an indicator indicating whether the SL PRS is for transmission or reception/measurement by the UE. In this way, some embodiments enable semi-persistent or aperiodic SL PRSs to be activated/deactivated or triggered on when SL positioning measurements are needed. Hence, the proposed solutions allow interference caused by SL PRS to other UEs to be reduced. In addition, the proposed solutions also reduce the SL overhead when compared to a periodic SL PRS transmission.

Some embodiments include methods for triggering SL PRS with DCI/SCI including indication of allocated resources for SL PRS and indication of whether the SL PRS is for transmission or for reception/measurement; methods for jointly triggering two SL PRSs with the same DCI/SCI wherein one is for transmission and the other is for reception/measurement; methods for jointly triggering more than two SL PRSs with the same DCI/SCI; and methods for triggering SL PRS with SL MAC CE.

In some embodiments, the resource allocation in the time domain comprises one or more of: a starting symbol of SL PRS, a length of SL PRS, and/or end symbol of SL PRS. In some embodiments, the resource allocation in the frequency domain comprises one or more of: a starting PRB of SL PRS, an end PRB of SL PRS, and/or number of PRBs allocated for SL PRS.

In some embodiments, the DCI is scrambled by an RNTI specific to triggering SL PRS. In some embodiments, the DCI uses a DCI format specific to triggering SL PRS. In some embodiments, the DCI triggers one SL PRS for transmission by the UE and a second SL PRS for reception/measurement by the UE.

In some embodiments, the DCI contains at least one of the following dedicated DCI fields for the one SL PRS for transmission by the UE: a first resource allocation in time domain (e.g., starting symbol of the one SL PRS, length of the one SL PRS, and/or end symbol of the one SL PRS); a first resource allocation in frequency domain (e.g., starting PRB of the one SL PRS, end PRB of the one SL PRS, and/or number of PRBs allocated for the one SL PRS); a first a comb factor associated with the one SL PRS; a first repetition factor associated with the one SL PRS; and a first identifier for the one SL PRS.

In some embodiments, the DCI contains at least one of the following dedicated DCI fields for the second SL PRS for reception/measurement by the UE: a second resource allocation in time domain; a second resource allocation in frequency domain; a second a comb factor associated with the second SL PRS; a second repetition factor associated with the second SL PRS; and a second identifier for the second SL PRS.

In some embodiments, the DCI indicates a second offset between the first SL PRS and the second SL PRS. In some embodiments, the DCI indicates a second offset between the DCI and the second SL PRS. In some embodiments, the resources for SL PRS are first configured to the UE by the network.

In some embodiments, the resource pools are predefined or preconfigured in time/frequency domain and a resource pool index is configured per SL PRS resource.

In some embodiments, the control signaling comprises a DCI with DCI Format 3-0 wherein the Cyclic Redundancy Check (CRC) of the DCI is scrambled by a new Radio Network Temporary Identifier (RNTI) that is specific to triggering a SL PRS.

In some embodiments, when DCI with DCI format 3_0 is scrambled with SL-PRS-RNTI, the UE understands that the DCI format 3_0 contains one or more of the following fields: one or more DCI fields for resource allocation in time—this field indicates one or more of starting symbol of SL PRS, length of SL PRS, and/or end symbol of SL PRS; one or more DCI fields for resource allocation in frequency domain; one or more fields can also indicate a comb factor of the SL PRS; one DCI field indicating an offset between the time in which the DCI is received and the time in which SL PRS will be transmitted; one or more fields indicating the number of repetitions for SL PRS; and a SL PRS ID is indicated in one of the DCI fields.

In some embodiments, a second sidelink UE that will receive or measure on the SL PRS needs to be informed of the SL PRS trigger so that the second sidelink UE can measure on the triggered SL PRS transmitted by another UE.

In some embodiments, the DCI includes a first ID of a first SL PRS a UE shall transmit and a second ID of a second SL PRS the UE shall receive.

In some embodiments, the first ID and the second ID are provided by either a common DCI field or separate DCI fields in the same DCI.

In some embodiments, the first stage SCI indicates via a field whether a 2nd stage SCI is triggered with SCI format 2-D.

### BRIEF DESCRIPTION OF THE DRAWINGS

The accompanying drawing FIGURES incorporated in and forming a part of this specification illustrate several aspects of the disclosure, and together with the description serve to explain the principles of the disclosure.

FIG. 1 illustrates that sidelink communication can occur in three different scenarios: In-Coverage (IC); Out-of-Coverage (OoC); and Partial Coverage (PC);

FIG. 2 illustrates an example of a DCI jointly triggering a first SL PRS for transmission by a UE and a second SL PRS for reception/measurement by the UE, according to some embodiments of the current disclosure;

FIG. 3 illustrates an example of a DCI jointly triggering a first SL PRS for transmission by a UE and a second and third SL PRS for reception/measurement by the UE, according to some embodiments of the current disclosure;

FIG. 4 illustrates a method performed by a UE for triggering SL PRS, according to some embodiments of the current disclosure;

FIG. 5 illustrates a method performed by a network node for triggering SL PRS, according to some embodiments of the current disclosure;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host, which may be an embodiment of the host of FIG. 6, in accordance with various aspects described herein;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

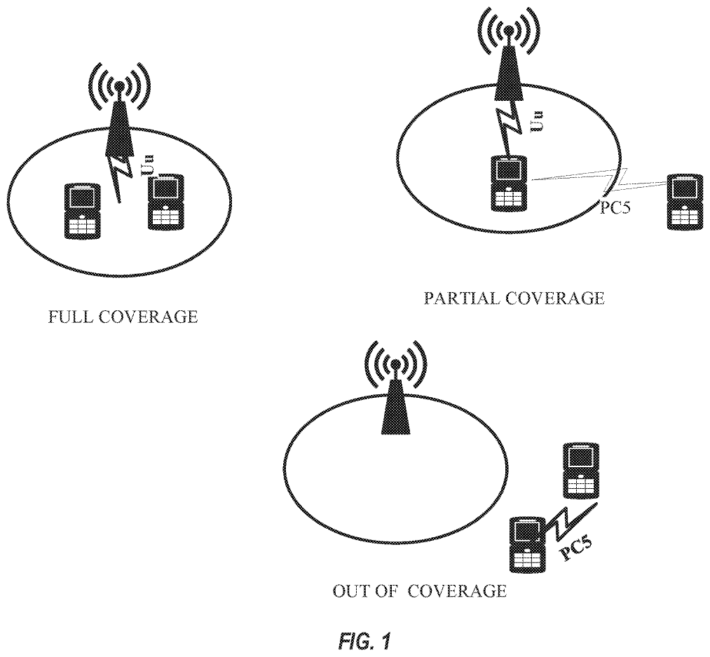

### DETAILED DESCRIPTION

The embodiments set forth below represent information to enable those skilled in the art to practice the embodiments and illustrate the best mode of practicing the embodiments. Upon reading the following description in light of the accompanying drawing FIGURES, those skilled in the art will understand the concepts of the disclosure and will recognize applications of these concepts not particularly addressed herein. It should be understood that these concepts and applications fall within the scope of the disclosure.

There currently exist certain challenge(s). As positioning for sidelink is a new feature, there are no reference signals currently defined in NR for performing SL positioning measurements. In ongoing Rel-18 discussions, SL PRS is being discussed. One option is to use a periodic SL PRS which is transmitted with a given periodicity and offset. However, such periodic SL PRS may cause interference to other UEs and may not be necessary when the UE(s) only need to perform SL positioning measurement when needed. How to introduce a type of SL PRS that reduces the interference to other UEs and at the same time reduces the SL overhead over periodic SL PRS transmissions is an open problem.

Certain aspects of the disclosure and their embodiments may provide solutions to these or other challenges. Systems and methods for activation and deactivation of Sidelink (SL) Positioning Reference Signal (PRS) are provided. In some embodiments, a method performed by a UE for triggering SL PRS includes: receiving control signaling for triggering SL PRS, where the control signaling includes one or more of: a resource allocation in time domain; a resource allocation in frequency domain; a comb factor associated with SL PRS; a repetition factor associated with SL PRS; an identifier for the SL PRS; an offset between the time in which the control signal is received and the time in which SL PRS will be transmitted or received/measured; and an indicator indicating whether the SL PRS is for transmission or reception/measurement by the UE. In this way, some embodiments enable semi-persistent or aperiodic SL PRSs to be activated/deactivated or triggered on when SL positioning measurements are needed. Hence, the proposed solutions allow interference caused by SL PRS to other UEs to be reduced. In addition, the proposed solutions also reduce the SL overhead when compared to a periodic SL PRS transmission.

Some embodiments include methods for triggering SL PRS with DCI/SCI including indication of allocated resources for SL PRS and indication of whether the SL PRS is for transmission or for reception/measurement; methods for jointly triggering two SL PRSs with the same DCI/SCI wherein one is for transmission and the other is for reception/measurement; methods for jointly triggering more than two SL PRSs with the same DCI/SCI; and methods for triggering SL PRS with SL MAC CE.

In some embodiments below, the term aperiodic SL PRS is used which refers to a SL PRS that is transmitted by a UE in SL to one or more other UEs which is triggered by a DCI or SCI. The aperiodic SL PRS transmission may consist of either a single SL PRS transmission or a small number of SL PRS transmission.

In some embodiments below, the term semi-persistent SL PRS is used which refers to a SL PRS that is transmitted by a UE in SL to one or more other UEs. Semi-persistent SL PRS has a periodicity and offset but is only transmitted from the time it is activated to the time it is deactivated.

### Aperiodic SL PRS Triggering by Network

In one embodiment, the resources for SL PRS are first configured to the UE by the network. In one example, the network node configuring the resources for SL PRS is the LMF (e.g., via LPP protocol). In another example, the network node configuring the resources for SL PRS is the serving gNB (e.g., via RRC). In some embodiments, the resource configuration includes information such as the following:
resource allocation in time domain (e.g., starting symbol of SL PRS, length of SL PRS, and/or end symbol of SL PRS)
resource allocation in frequency domain (e.g., starting PRB of SL PRS, end PRB of SL PRS, and/or number of PRBs allocated for SL PRS). Other resource allocation parameters in frequency domain may include comb factor of SL PRS (i.e., number of subcarriers or REs in between two SL PRS samples in the frequency domain)

In some embodiments, resource pools may be predefined or preconfigured in time/frequency domain and a resource pool index may be configured per SL PRS resource.

In one embodiment, the gNB sends a DCI to trigger (or activate) a SL PRS to a SL UE that will transmit the SL PRS. In one sub-embodiment, the gNB sends a DCI with DCI Format 3-0 wherein the CRC (cyclic redundancy check) of the DCI is scrambled by a new RNTI (radio network temporary identifier) that is specific to triggering a SL PRS. For instance, the new RNTI can be called SL-PRS-RNTI. In some embodiments, when DCI with DCI format 3_0 is scrambled with SL-PRS-RNTI, the UE understands that the DCI format 3_0 contains one or more of the following fields:
one or more DCI fields for resource allocation in time—this field indicates one or more of starting symbol of SL PRS, length of SL PRS, and/or end symbol of SL PRS
one or more DCI fields for resource allocation in frequency domain (e.g., starting PRB of SL PRS, end PRB of SL PRS, and/or number of PRBs allocated for SL PRS). The one or more fields can also indicate a comb factor of the SL PRS.
one DCI field indicating an offset between the time in which the DCI is received and the time in which SL PRS will be transmitted. The offset may be indicated in units of slots or symbols.
one or more fields indicating the number of repetitions for SL PRS. In one embodiment, the repeated SL PRSs may have a gap of N symbols between two consecutive SL PRS repetitions. In an alternative embodiment, there is no gap between two consecutive SL PRS repetitions.
in some cases, a SL PRS ID may be indicated in one of the DCI fields. In this case, the resource allocation for the SL PRS may be preconfigured either via LPP by the LMF or via RRC by the gNB, and each such resource allocation is associated with a SL PRS ID. Hence, the SL UE would know the resource allocation for the SL PRS from the SL PRS ID.

In another embodiment, a second sidelink UE that will receive or measure on the SL PRS needs to be informed of the SL PRS trigger so that the second sidelink UE can measure on the triggered SL PRS transmitted by another SL UE. In this case, the gNB can send a DCI to trigger (or activate) a SL PRS to the second SL UE that will receive the SL PRS. In one embodiment, the gNB can send a DCI with DCI Format 3-0 wherein the CRC of the DCI is scrambled by a SL-PRS-RNTI similar to what is described above. This DCI may contain one or more of the fields described in the above embodiment (e.g., time domain resource allocation, frequency domain resource allocation, offset between DCI and SL PRS and/or SL PRS ID). In an extension of this embodiment, the gNB can send a DCI with DCI Format 3-0 to one or more additional sidelink UEs that will receive the SL PRS. In one particular example, the DCI may be a group common DCI that can be received by the one or more additional sidelink UEs that will receive the SL PRS.

In some embodiments, there is a need to distinguish between whether the triggered SL PRS is for transmission by a SL UE or whether the triggered SL PRS is for reception by a SL UE. Hence, in one embodiment, a field is added in DCI (e.g., DCI with DCI format 3_0) to distinguish between whether the SL PRS is for reception/measurement or transmission. If the DCI field indicates a first value, then the triggered SL PRS is for reception. If the DCI field indicates a second value, then the triggered SL PRS is for transmission.

In another alternative embodiment, whether the triggered SL PRS is for reception/measurement or transmission is differentiated by using different RNTIs. For example, if DCI (e.g., DCI format 3_0) has its CRC scrambled by a SL-PRS-Tx-RNTI (which is specific to SL PRS transmission), then the UE knows that the triggered SL PRS is for transmission. On the other hand, if DCI (e.g., DCI format 3_0) has its CRC scrambled by a SL-PRS-Rx-RNTI (which is specific to SL PRS reception/measurement), then the UE knows that the triggered SL PRS is for reception/measurement.

The above embodiments are written such that a RNTI is used to differentiate DCI that is used for triggering SL PRS over DCIs that are used for SL communication (e.g., DCIs that are used for scheduling of NR PSCCH and NR PSSCH as defined in 3GPP TS 38.212 V17.2.0). Instead of relying on an RNTI to do this differentiation, a new DCI format may be introduced in 3GPP specifications that is specifically defined for triggering SL PRS. For instance, a new DCI format (e.g., DCI format 3_2) may be introduced for triggering SL PRS. This new DCI format contains one or more of the DCI fields described in the above embodiments.

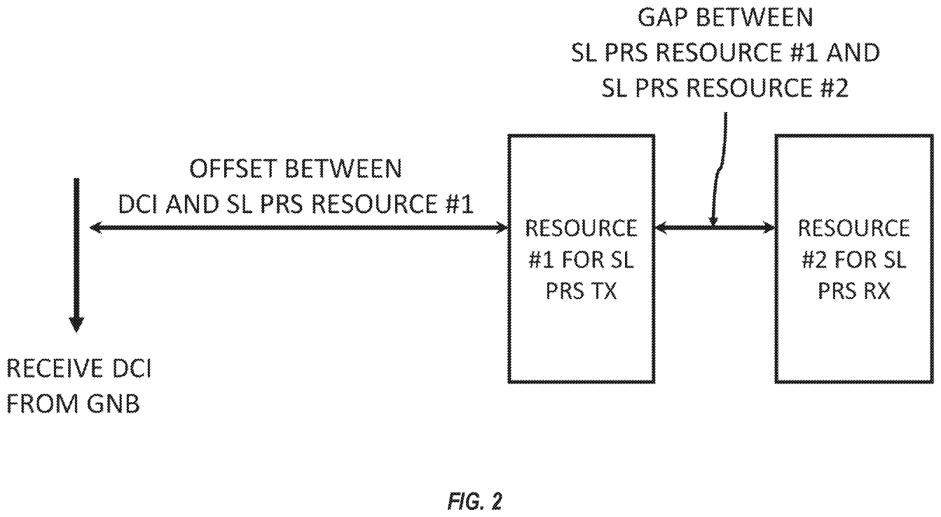

In some embodiments, a UE that will be performing RTT based positioning has a need to both transmit and receive SL PRSs. For example, consider UE1 and UE2 which are to participate in RTT based positioning. In this case, UE1 will first transmit SL PRS 1 which UE2 will measure. Then, UE2 will transmit SL PRS 2 which UE1 will measure. Hence, both SL PRS 1 and SL PRS 2 need to be triggered jointly by the gNB. FIG. 2 shows an example of such a DCI. In this example the gNB triggers both the SL PRS for transmission and SL PRS for reception using the same DCI. FIG. 2 illustrates an example of a DCI jointly triggering a first SL PRS for transmission by a UE and a second SL PRS for reception/measurement by the UE. This DCI may contain one or more of the following fields:
one or more DCI fields for resource allocation in time for Resource #1 (i.e., Resource for SL PRS to be transmitted)—this field indicates one or more of starting symbol of SL PRS, length of SL PRS, and/or end symbol of SL PRS.
one or more DCI fields for resource allocation in frequency domain for Resource #1 (e.g., starting PRB of SL PRS, end PRB of SL PRS, and/or number of PRBs allocated for SL PRS). The one or more fields can also indicate a comb factor of the SL PRS.
one DCI field indicating an offset between the time in which the DCI is received and the time in which SL PRS in Resource #1 will be transmitted. The offset may be indicated in units of slots or symbols.
one or more DCI fields for resource allocation in time for Resource #2 (i.e., Resource for SL PRS to be received/measured)—this field indicates one or more of starting symbol of SL PRS, length of SL PRS, and/or end symbol of SL PRS.
one or more DCI fields for resource allocation in frequency domain for Resource #2 (e.g., starting PRB of SL PRS, end PRB of SL PRS, and/or number of PRBs allocated for SL PRS). The one or more fields can also indicate a comb factor of the SL PRS.
one DCI field indicating a second offset between the time in which the DCI is received and the time in which SL PRS in Resource #2 will be transmitted. Alternatively, the second offset (or Gap) may be between SL PRS in Resource #1 and SL PRS in Resource #2). The second offset (or Gap) may be indicated in units of slots or symbols.

In another embodiment, the DCI may include a first ID of a first SL PRS a SL UE shall transmit and a second ID of a second SL PRS the SL UE shall receive. The first ID and the second ID may be provided by either a common DCI field or separate DCI fields in the same DCI.

Aperiodic SL PRS Triggering by Network with Extension to Multi-RTT/Groupcast Scenario

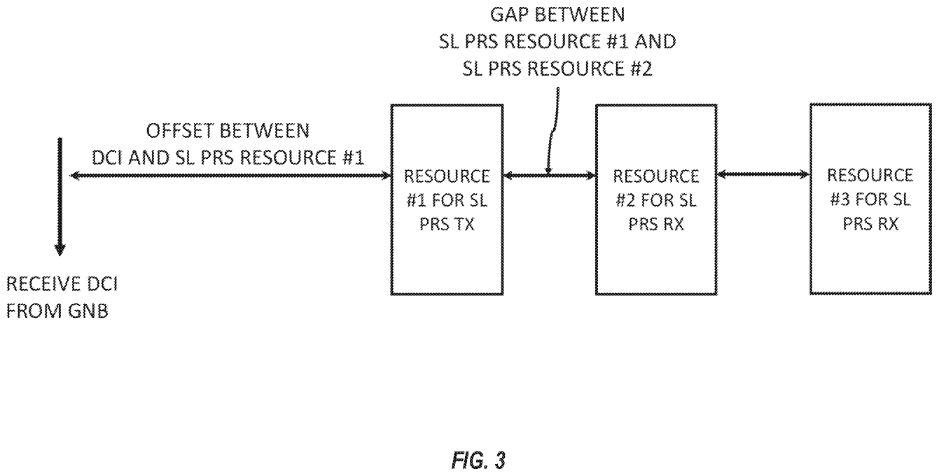

In some embodiments, a UE that will be performing Multi-RTT based positioning has a need to both transmit and receive SL PRSs. For example, consider UE1, UE2 and UE3 which are to participate in RTT based positioning. In this case, UE1 will first transmit SL PRS 1 which UE2 and UE3 will measure. Then, UE2 will transmit SL PRS 2 which UE1 will measure, and optionally UE3 will measure. Finally, UE3 will transmit SL PRS3 which UE1 will measure, and optionally UE2 will measure. Hence, in this case, SL PRS 1, SL PRS 2 and SL PRS 3 need to be triggered jointly by the gNB. FIG. 3 shows an example of such a DCI. FIG. 3 illustrates an example of a DCI jointly triggering a first SL PRS for transmission by a UE and a second and third SL PRS for reception/measurement by the UE. In this example the gNB triggers both the SL PRS for transmission and SL PRS for reception using the same DCI. The scheme can be used for an arbitrary but limited number of involved SL UEs. This DCI may contain one or more of the following fields:
a. for each SL PRS resource:
   i. one DCI field indicating an offset between the time in which the DCI is received and the time in which the resource will be transmitted. The offset may be indicated in units of slots or symbols;
      1. Alternatively, the offset (or Gap) may be between the SL PRS Resource and the preceding SL PRS in Resource). The second offset (or Gap) may be indicated in units of slots or symbols. This alternative format cannot be used for the first SL PRS Resource.
   ii. one or more DCI fields for resource allocation in time for the resource (i.e., Resource for SL PRS to be transmitted)—this field indicates one or more of starting symbol of SL PRS, length of SL PRS, and/or end symbol of SL PRS;
   iii. one or more DCI fields for resource allocation in frequency domain for the resource (e.g., starting PRB of SL PRS, end PRB of SL PRS, and/or number of PRBs allocated for SL PRS). The one or more fields can also indicate a comb factor of the SL PRS;
   iv. Optionally, one or more DCI fields may indicate which UE(s) shall receive/measure each SL PRS resource via indication of an ID representing the one or more UEs.

### Aperiodic SL PRS Triggering by SL UE

In this embodiment, the resources for SL PRS may be configured to a SL UE either via the network or another SL UE. When network node configures the resources for SL PRS either LPP (when LMF configures the SL PRS resources) or RRC (when gNB configures the SL PRS resources) can be used. In another example, the resources for SL PRS are configured to the SL UE by a second SL UE (e.g., via PC5 interface). In these embodiments, resource pools may be predefined or preconfigured in time/frequency domain and a resource pool index may be configured per SL PRS resource.

In one embodiment, a two stage SCI (sidelink control information) can be used to trigger (or activate) a SL PRS to a SL UE by a second SL UE. Two stage SCI here means that there are two SCIs: the first SCI provides information on the second SCI, and the second SCI triggers the SL PRS. In one embodiment, a new SCI format is introduced for the 2nd stage SCI that is different from the 2nd stage SCI formats that are used for SL communications (i.e., the new 2nd stage SCI is different from SCI format 2-A, SCI format 2-B, and SCI format 2-C that is specified in 3GPP TS 38.212 v17.2.0). This new second stage SCI format that is specific to triggering (or activating SL PRS) may be called SCI format 2-D in 3GPP specifications. SCI format 2-D may contain one or more of the fields described in the embodiments related to DCI (e.g., time domain resource allocation for SL PRS, frequency domain allocation for SL PRS, offset between 2nd stage SCI and SL PRS and/or SL PRS ID).

In one embodiment, the first stage SCI indicates via a field in the first stage SCI, whether the 2nd stage SCI is triggered with SCI format 2-D. Table 8.3.1.1-1 below shows an example where the codepoint ‘11’ in the ‘2nd-stage SCI format field’ in the 1st stage SCI is used to indicate to the receiving SL UE that the 2nd stage SCI will trigger (or activate) SL PRSs. That way the receiving SL UE can differentiate a 2nd stage SCI that is intended for intriguing SL communication (e.g., via SCI format 2-A) from a 2nd stage SCI that is intended to trigger (or activate) SL PRSs.

TABLE 8.3.1.1-1
2nd-stage SCI formats (modified from 3GPP TS 38.212 V17.2.0)

| Value of 2nd-stage | |
|---|---|
| SCI format field | 2nd-stage SCI format |
| 00 | SCI format 2-A |
| 01 | SCI format 2-B |
| 10 | SCI format 2-C |
| 11 | SCI format 2-D |

In one embodiment, the embodiments discussed above can be easily extended to cover multi-RTT/groupcast scenario following procedures described above.

Although the embodiments above are written from the perspective of triggering Aperiodic SL PRS, the triggering mechanisms proposed herein are equally applicable for triggering semi-persistent SL PRS. One difference in the semi-persistent SL PRS case may be that the SL PRS may be configured with a periodicity and an offset. Once the semi-persistent SL PRS is activated (using the methods discussed above), then SL PRS transmission is transmitted with the configured periodicity and is offset by a slot offset configured. In some embodiments, the number of periodicities for which semi-persistent SL PRS shall be transmitted or received shall be indicated as a field in DCI or SCI. In another embodiment, the semi-persistent SL PRS may be deactivated by a second DCI or SCI (i.e., after a first DCI or SCI activates a semi-persistent SL PRS, then a second DCI or SCI is used to deactivate the semi-persistent SL PRS). A third embodiment is to configure the number of periodicities for which semi-persistent SL PRS shall be transmitted or received as a configuration parameter.

### Semi-Persistent SL PRS Activation by SL MAC CE

In this embodiment, the resources for SL PRS may be configured to a SL UE either via the network or another SL UE. When network node configures the resources for SL PRS either LPP (when LMF configures the SL PRS resources) or RRC (when gNB configures the SL PRS resources) can be used. In another example, the resources for SL PRS are configured to the SL UE by a second SL UE (e.g., via PC5 interface). In these embodiments, resource pools may be predefined or preconfigured in time/frequency domain and a resource pool index may be configured per SL PRS resource.

In one embodiment, a SL MAC CE can be used to trigger (or activate) a SL PRS to a SL UE by a second SL UE. The SL MAC CE may contain one or more of the fields described in the embodiments related to DCI and SCI (e.g., time domain resource allocation for SL PRS, frequency domain allocation for SL PRS, offset between 2nd stage SCI and SL PRS and/or SL PRS ID).

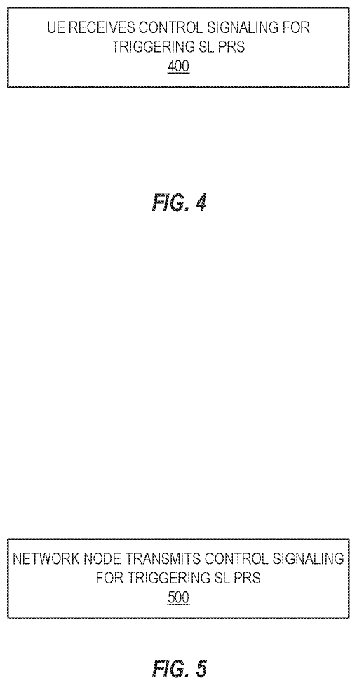

FIG. 4 illustrates a method performed by a UE for triggering SL PRS including one or more of: receiving control signaling for triggering SL PRS (step 400). FIG. 5 illustrates a method performed by a network node for triggering SL PRS including one or more of: transmitting control signaling for triggering SL PRS (step 500).

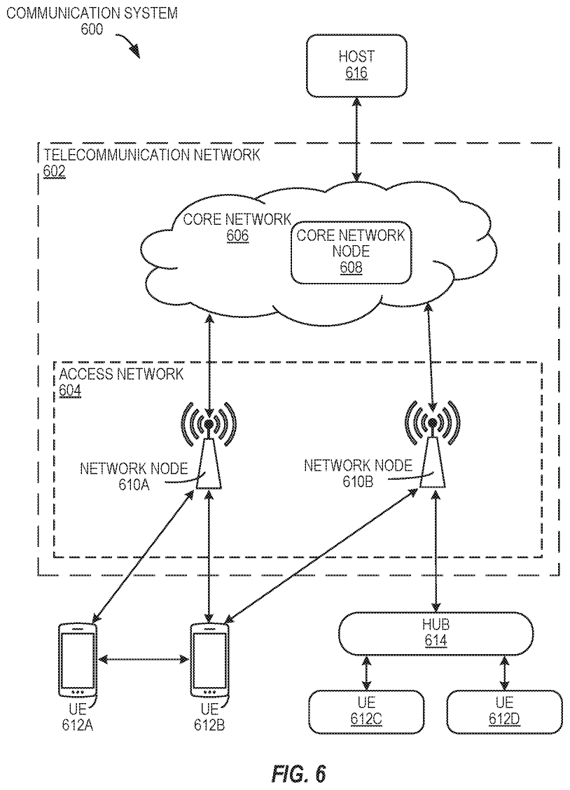

FIG. 6 shows an example of a communication system 600 in accordance with some embodiments.

In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar Third Generation Partnership Project (3GPP) access node or non-3GPP Access Point (AP). The network nodes 610 facilitate direct or indirect connection of User Equipment (UE), such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602 and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

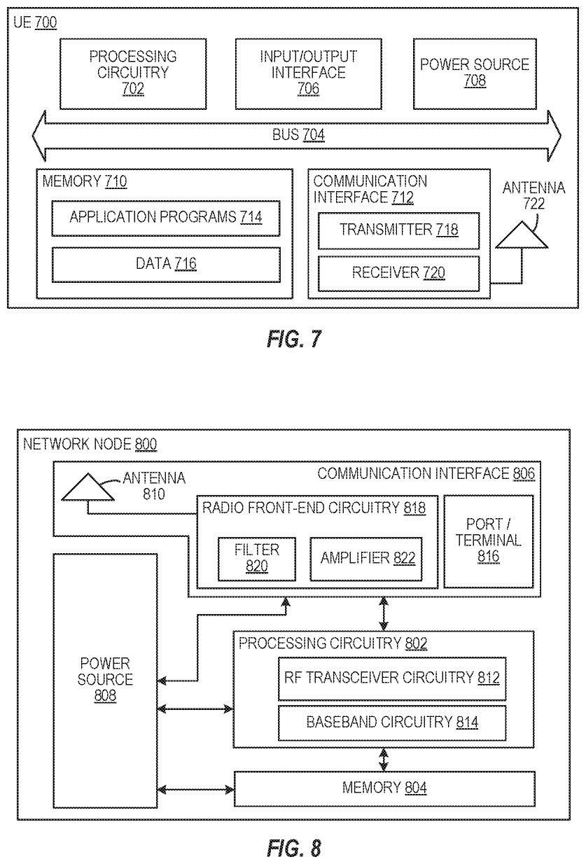

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O & M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a Node B component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., an antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous FIGURES, such as FIGS. 7 and 8, such that the descriptions thereof are generally applicable to the corresponding components of the host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

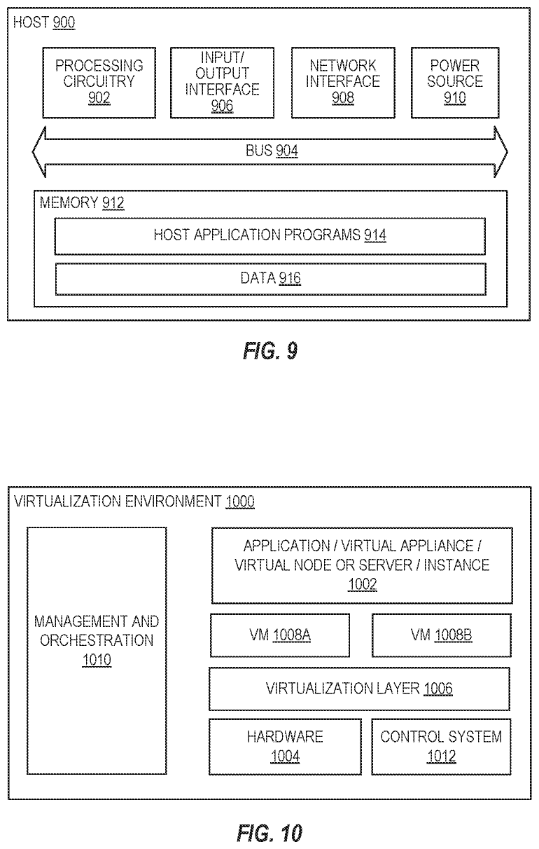

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment 900 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1012 which may alternatively be used for communication between hardware nodes and radio units.

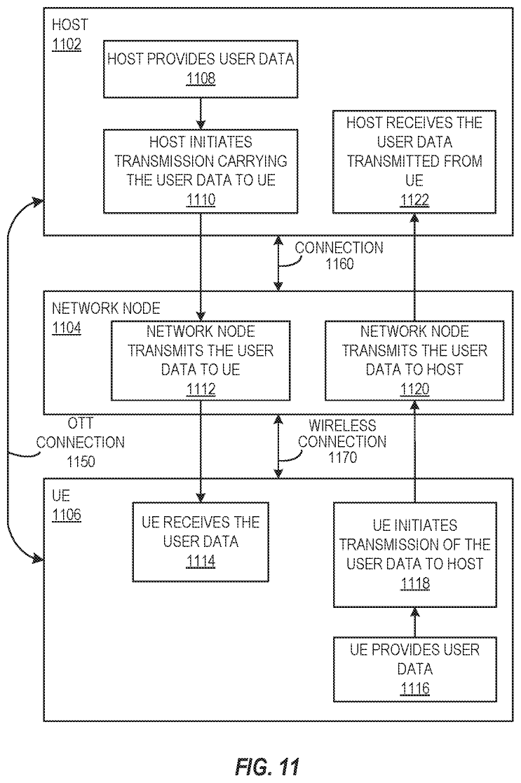

FIG. 11 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 6 and/or the UE 700 of FIG. 7), the network node (such as the network node 610A of FIG. 6 and/or the network node 800 of FIG. 8), and the host (such as the host 616 of FIG. 6 and/or the host 900 of FIG. 9) discussed in the preceding paragraphs will now be described with reference to FIG. 11.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106 via a connection 1160. The connection 1160 may be direct or pass through a core network (like the core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole and/or by end users and a wireless network generally.

### EMBODIMENTS

### Group A Embodiments

Embodiment 1: A method performed by a User Equipment, UE, for triggering Sidelink, SL, Positioning Reference Signal, PRS, the method comprising one or more of: a.
receiving (400) control signaling for triggering SL PRS, where the control signaling includes one or more of: i. resource allocation in time domain (e.g., starting symbol of SL PRS, length of SL PRS, and/or end symbol of SL PRS); ii. resource allocation in frequency domain (e.g., starting PRB of SL PRS, end PRB of SL PRS, and/or number of PRBs allocated for SL PRS); iii. a comb factor associated with SL PRS; iv. a repetition factor associated with SL PRS; v. an identifier for the SL PRS; vi. an offset between the time in which the control signal is receive and the time in which SL PRS will be transmitted or received/measured; and vii. an indicator indicating whether the SL PRS is for transmission or reception/measurement by the UE.

Embodiment 2: The method of any of the previous embodiments wherein: the UE is a SL UE.

Embodiment 3: The method of any of the previous embodiments wherein: the control signing is contained in a DCI and is sent to the UE by the gNB.

Embodiment 4: The method of any of the previous embodiments wherein: the DCI is scrambled by an RNTI specific to triggering SL PRS (i.e., an RNTI that is different from the RNTIs used for scheduling SL communication related channels (e.g., different from SL-RNTI or SL-CS-RNTI used for scheduling NR PSCCH and NR PSSCH).

Embodiment 5: The method of any of the previous embodiments wherein: the DCI uses a DCI format specific to triggering SL PRS (i.e., a DCI format that is different from the DCI formats used for scheduling SL communication related channels (e.g., different from DCI format 3_0 used for scheduling NR PSCCH and NR PSSCH).

Embodiment 6: The method of any of the previous embodiments wherein: the DCI triggers one SL PRS for transmission by the UE and a second SL PRS for reception/measurement by the UE.

Embodiment 7: The method of any of the previous embodiments wherein: the DCI contains at least one of the following dedicated DCI fields for the one SL PRS for transmission by the UE: a. a first resource allocation in time domain (e.g., starting symbol of the one SL PRS, length of the one SL PRS, and/or end symbol of the one SL PRS); b. a first resource allocation in frequency domain (e.g., starting PRB of the one SL PRS, end PRB of the one SL PRS, and/or number of PRBs allocated for the one SL PRS); c. a first a comb factor associated with the one SL PRS; d. a first repetition factor associated with the one SL PRS; and e. a first identifier for the one SL PRS.

Embodiment 8: The method of any of the previous embodiments wherein: the DCI contains at least one of the following dedicated DCI fields for the second SL PRS for reception/measurement by the UE: a. a second resource allocation in time domain (e.g., starting symbol of the second SL PRS, length of the second SL PRS, and/or end symbol of the second SL PRS); b. a second resource allocation in frequency domain (e.g., starting PRB of the second SL PRS, end PRB of the second SL PRS, and/or number of PRBs allocated for the second SL PRS); c. a second a comb factor associated with the second SL PRS; d. a second repetition factor associated with the second SL PRS; and e. a second identifier for the second SL PRS.

Embodiment 9: The method of any of the previous embodiments wherein: the DCI indicates a second offset between the first SL PRS and the second SL PRS.

Embodiment 10: The method of any of the previous embodiments wherein: the DCI indicates a second offset between the DCI and the second SL PRS.

Embodiment 11: The method of any of the previous embodiments wherein: the resources for SL PRS are first configured to the UE by the network.

Embodiment 12: The method of any of the previous embodiments wherein: resource pools are predefined or preconfigured in time/frequency domain and a resource pool index may be configured per SL PRS resource.

Embodiment 13: The method of any of the previous embodiments wherein: the control signaling comprises a DCI with DCI Format 3-0 wherein the CRC (cyclic redundancy check) of the DCI is scrambled by a new RNTI (radio network temporary identifier) that is specific to triggering a SL PRS.

Embodiment 14: The method of any of the previous embodiments wherein: when DCI with DCI format 3_0 is scrambled with SL-PRS-RNTI, the UE understands that the DCI format 3_0 contains one or more of the following fields: a. one or more DCI fields for resource allocation in time—this field indicates one or more of starting symbol of SL PRS, length of SL PRS, and/or end symbol of SL PRS; b. one or more DCI fields for resource allocation in frequency domain (e.g., starting PRB of SL PRS, end PRB of SL PRS, and/or number of PRBs allocated for SL PRS). The one or more fields can also indicate a comb factor of the SL PRS; c. one DCI field indicating an offset between the time in which the DCI is received and the time in which SL PRS will be transmitted. The offset may be indicated in units of slots or symbols; d. one or more fields indicating the number of repetitions for SL PRS. In one embodiment, the repeated SL PRSs may have a gap of N symbols between two consecutive SL PRS repetitions; and e. a SL PRS ID is indicated in one of the DCI fields.

Embodiment 15: The method of any of the previous embodiments wherein: a second sidelink UE that will receive or measure on the SL PRS needs to be informed of the SL PRS trigger so that the second sidelink UE can measure on the triggered SL PRS transmitted by another UE.

Embodiment 16: The method of any of the previous embodiments wherein: the DCI may include a first ID of a first SL PRS a UE shall transmit and a second ID of a second SL PRS the UE shall receive.

Embodiment 17: The method of any of the previous embodiments wherein: the first ID and the second ID may be provided by either a common DCI field or separate DCI fields in the same DCI.

Embodiment 18: The method of any of the previous embodiments, further comprising: providing user data; and forwarding the user data to a host via the transmission to the network node.

### Group B Embodiments

Embodiment 19: A method performed by a network node for triggering Sidelink, SL, Positioning Reference Signal, PRS, the method comprising one or more of: a. transmitting (500) control signaling for triggering SL PRS, where the control signaling includes one or more of: i. resource allocation in time domain (e.g., starting symbol of SL PRS, length of SL PRS, and/or end symbol of SL PRS); ii. resource allocation in frequency domain (e.g., starting PRB of SL PRS, end PRB of SL PRS, and/or number of PRBs allocated for SL PRS); iii.
a comb factor associated with SL PRS; iv. a repetition factor associated with SL an identifier for the SL PRS; vi. an offset between the time in which the control PRS; v. signal is receive and the time in which SL PRS will be transmitted or received/measured; and vii.
an indicator indicating whether the SL PRS is for transmission or reception/measurement by the UE.

Embodiment 20: The method of any of the previous embodiments wherein: the UE is a SL UE.

Embodiment 21: The method of any of the previous embodiments wherein: the control signing is contained in a DCI and is sent to the UE by the gNB.

Embodiment 22: The method of any of the previous embodiments wherein: the DCI is scrambled by an RNTI specific to triggering SL PRS (i.e., an RNTI that is different from the RNTIs used for scheduling SL communication related channels (e.g., different from SL-RNTI or SL-CS-RNTI used for scheduling NR PSCCH and NR PSSCH).

Embodiment 23: The method of any of the previous embodiments wherein: the DCI uses a DCI format specific to triggering SL PRS (i.e., a DCI format that is different from the DCI formats used for scheduling SL communication related channels (e.g., different from DCI format 3_0 used for scheduling NR PSCCH and NR PSSCH).

Embodiment 24: The method of any of the previous embodiments wherein: the DCI triggers one SL PRS for transmission by the UE and a second SL PRS for reception/measurement by the UE.

Embodiment 25: The method of any of the previous embodiments wherein: the DCI contains at least one of the following dedicated DCI fields for the one SL PRS for transmission by the UE: a. a first resource allocation in time domain (e.g., starting symbol of the one SL PRS, length of the one SL PRS, and/or end symbol of the one SL PRS); b. a first resource allocation in frequency domain (e.g., starting PRB of the one SL PRS, end PRB of the one SL PRS, and/or number of PRBs allocated for the one SL PRS); c. a first a comb factor associated with the one SL PRS; d. a first repetition factor associated with the one SL PRS; and e. a first identifier for the one SL PRS.

Embodiment 26: The method of any of the previous embodiments wherein: the DCI contains at least one of the following dedicated DCI fields for the second SL PRS for reception/measurement by the UE: a. a second resource allocation in time domain (e.g., starting symbol of the second SL PRS, length of the second SL PRS, and/or end symbol of the second SL PRS); b. a second resource allocation in frequency domain (e.g., starting PRB of the second SL PRS, end PRB of the second SL PRS, and/or number of PRBs allocated for the second SL PRS); c. a second a comb factor associated with the second SL PRS; d. a second repetition factor associated with the second SL PRS; and e. a second identifier for the second SL PRS.

Embodiment 27: The method of any of the previous embodiments wherein: the DCI indicates a second offset between the first SL PRS and the second SL PRS.

Embodiment 28: The method of any of the previous embodiments wherein: the DCI indicates a second offset between the DCI and the second SL PRS.

Embodiment 29: The method of any of the previous embodiments wherein: the resources for SL PRS are first configured to the UE by the network.

Embodiment 30: The method of any of the previous embodiments wherein: resource pools are predefined or preconfigured in time/frequency domain and a resource pool index may be configured per SL PRS resource.

Embodiment 31: The method of any of the previous embodiments wherein: the control signaling comprises a DCI with DCI Format 3-0 wherein the CRC (cyclic redundancy check) of the DCI is scrambled by a new RNTI (radio network temporary identifier) that is specific to triggering a SL PRS.

Embodiment 32: The method of any of the previous embodiments wherein: when DCI with DCI format 3_0 is scrambled with SL-PRS-RNTI, the UE understands that the DCI format 3_0 contains one or more of the following fields: a. one or more DCI fields for resource allocation in time—this field indicates one or more of starting symbol of SL PRS, length of SL PRS, and/or end symbol of SL PRS; b. one or more DCI fields for resource allocation in frequency domain (e.g., starting PRB of SL PRS, end PRB of SL PRS, and/or number of PRBs allocated for SL PRS). The one or more fields can also indicate a comb factor of the SL PRS; c.
one DCI field indicating an offset between the time in which the DCI is received and the time in which SL PRS will be transmitted. The offset may be indicated in units of slots or symbols; d. one or more fields indicating the number of repetitions for SL PRS. In one embodiment, the repeated SL PRSs may have a gap of N symbols between two consecutive SL PRS repetitions; and e. a SL PRS ID is indicated in one of the DCI fields.

Embodiment 33: The method of any of the previous embodiments wherein: a second sidelink UE that will receive or measure on the SL PRS needs to be informed of the SL PRS trigger so that the second sidelink UE can measure on the triggered SL PRS transmitted by another UE.

Embodiment 34: The method of any of the previous embodiments wherein: the DCI may include a first ID of a first SL PRS a UE shall transmit and a second ID of a second SL PRS the UE shall receive.

Embodiment 35: The method of any of the previous embodiments wherein: the first ID and the second ID may be provided by either a common DCI field or separate DCI fields in the same DCI.

Embodiment 36: The method of any of the previous embodiments, further comprising: obtaining user data; and forwarding the user data to a host or a user equipment.

### Group C Embodiments

Embodiment 37: A user equipment for triggering Sidelink, SL, Positioning Reference Signal, PRS, comprising: processing circuitry configured to perform any of the steps of any of the Group A embodiments; and power supply circuitry configured to supply power to the processing circuitry.

Embodiment 38: A network node for triggering Sidelink, SL, Positioning Reference Signal, PRS, the network node comprising: processing circuitry configured to perform any of the steps of any of the Group B embodiments; power supply circuitry configured to supply power to the processing circuitry.

Embodiment 39: A user equipment, UE, for triggering Sidelink, SL, Positioning Reference Signal, PRS, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 40: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 41: The host of the previous embodiment, wherein the cellular network further includes a network node configured to communicate with the UE to transmit the user data to the UE from the host.

Embodiment 42: The host of the previous 2 embodiments, wherein: the processing circuitry of the host is configured to execute a host application, thereby providing the user data; and the host application is configured to interact with a client application executing on the UE, the client application being associated with the host application.

Embodiment 43: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 44: The method of the previous embodiment, further comprising: at the host, executing a host application associated with a client application executing on the UE to receive the user data from the UE.

Embodiment 45: The method of the previous embodiment, further comprising: at the host, transmitting input data to the client application executing on the UE, the input data being provided by executing the host application, wherein the user data is provided by the client application in response to the input data from the host application.

Embodiment 46: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 47: The host of the previous embodiment, wherein the cellular network further includes a network node configured to communicate with the UE to transmit the user data from the UE to the host.

Embodiment 48: The host of the previous 2 embodiments, wherein: the processing circuitry of the host is configured to execute a host application, thereby providing the user data; and the host application is configured to interact with a client application executing on the UE, the client application being associated with the host application.

Embodiment 49: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 50: The method of the previous embodiment, further comprising: at the host, executing a host application associated with a client application executing on the UE to receive the user data from the UE.

Embodiment 51: The method of the previous embodiment, further comprising: at the host, transmitting input data to the client application executing on the UE, the input data being provided by executing the host application, wherein the user data is provided by the client application in response to the input data from the host application.

Embodiment 52: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 53: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 54: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 55: The method of the previous embodiment, further comprising, at the network node, transmitting the user data provided by the host for the UE.

Embodiment 56: The method of any of the previous 2 embodiments, wherein the user data is provided at the host by executing a host application that interacts with a client application executing on the UE, the client application being associated with the host application.

Embodiment 57: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 58: The communication system of the previous embodiment, further comprising: the network node; and/or the user equipment.

Embodiment 59: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 60: The host of the previous 2 embodiments, wherein: the processing circuitry of the host is configured to execute a host application, thereby providing the user data; and the host application is configured to interact with a client application executing on the UE, the client application being associated with the host application.

Embodiment 61: The host of the any of the previous 2 embodiments, wherein the initiating receipt of the user data comprises requesting the user data.

Embodiment 62: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 63: The method of the previous embodiment, further comprising at the network node, transmitting the received user data to the host.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
AF Application Function.
AMF Access and Mobility Function
AN Access Network
AP Access Point
ASIC Application Specific Integrated Circuit
AUSF Authentication Server Function
CPU Central Processing Unit
CRC Cyclic Redundancy Check
DCI Downlink Control Information.
DN Data Network
DSP Digital Signal Processor
eNB Enhanced or Evolved Node B
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MME Mobility Management Entity
MTC Machine Type Communication
NEF Network Exposure Function
NF Network Function.
NR New Radio
NRF
NSSF
Network Function Repository Function
Network Slice Selection Function
OTT Over-the-Top
PC Personal Computer
PCF Policy Control Function
P-GW Packet Data Network Gateway
PRB Physical Resource Block
PRS Positioning Reference Signal
QoS Quality of Service
RAM Random Access Memory
RAN Radio Access Network
RNTI Radio Network Temporary Identifier
ROM Read Only Memory
RRH Remote Radio Head
RTT Round Trip Time
SCEF Service Capability Exposure Function
SL Sidelink
SMF Session Management Function
UDM Unified Data Management
UE User Equipment.
UPF User Plane Function

Those skilled in the art will recognize improvements and modifications to the embodiments of the present disclosure. All such improvements and modifications are considered within the scope of the concepts disclosed herein.

1-46. (canceled)

47. A method performed by a User Equipment, UE, for triggering Sidelink, SL, Positioning Reference Signal, PRS, the method comprising:
receiving control signaling for triggering SL PRS, where the control signaling includes one or more of:
a resource allocation in time domain;
a resource allocation in frequency domain;
a comb factor associated with SL PRS;
a repetition factor associated with SL PRS;
an identifier for the SL PRS; and
an offset between the time in which the control signal is received and the time in which SL PRS will be transmitted or received/measured.

48. The method of claim 47 wherein the resource allocation in the time domain comprises one or more of: a starting symbol of SL PRS, a length of SL PRS, and/or end symbol of SL PRS, and
wherein the resource allocation in the frequency domain comprises one or more of: a starting Physical Resource Block, PRB, of SL PRS, an end PRB of SL PRS, and/or number of PRBs allocated for SL PRS.

49. The method of claim 47 wherein the control signaling is received via a downlink control information, DCI.

50. The method of claim 49 wherein: the DCI is scrambled by a Radio Network Temporary Identifier, RNTI, specific to triggering SL PRS, or
wherein the DCI uses a DCI format specific to triggering SL PRS.

51. The method of claim 49 wherein: the DCI triggers at least one of: one SL PRS for transmission by the UE and a second SL PRS for reception/measurement by the UE.

52. The method of claim 49 wherein: the DCI contains one or more dedicated DCI fields that indicate at least one of the following for the one SL PRS for transmission by the UE:
a first resource allocation in time domain;
a first resource allocation in frequency domain;
a first a comb factor associated with the one SL PRS;
a first repetition factor associated with the one SL PRS; and
a first identifier for the one SL PRS, and/or
wherein the DCI contains one or more dedicated DCI fields that indicate at least one of the following for the second SL PRS for reception/measurement by the UE:
a second resource allocation in time domain;
a second resource allocation in frequency domain;
a second a comb factor associated with the second SL PRS;
a second repetition factor associated with the second SL PRS; and
a second identifier for the second SL PRS.

53. The method of claim 49 wherein: when DCI with DCI format 3_0 is scrambled with SL-PRS-RNTI, the UE understands that the DCI format 3_0 contains one or more of the following fields:
one or more DCI fields for resource allocation in time—this field indicates one or more of starting symbol of SL PRS, length of SL PRS, and/or end symbol of SL PRS;
one or more DCI fields for resource allocation in frequency domain;
one or more fields can also indicate a comb factor of the SL PRS;
one DCI field indicating an offset between the time in which the DCI is received and the time in which SL PRS will be transmitted;
one or more fields indicating the number of repetitions for SL PRS; and
a SL PRS ID is indicated in one of the DCI fields.

54. The method of claim 47 wherein: the DCI includes a first ID of a first SL PRS the UE shall transmit and a second ID of a second SL PRS the UE shall receive, and
wherein the first ID and the second ID are provided by either a common DCI field or separate DCI fields in the same DCI.

55. The method of claim 47 wherein the control signaling is received via a first stage sidelink control information, SCI, and a second stage SCI, and wherein: the first stage SCI indicates via a field whether the 2nd stage SCI is triggered with SCI format 2-D.

56. A method performed by a network node for triggering Sidelink, SL, Positioning Reference Signal, PRS, the method comprising one or more of:
transmitting, to a User Equipment, UE, control signaling for triggering SL PRS, where the control signaling includes one or more of:
a resource allocation in time domain;
a resource allocation in frequency domain;
a comb factor associated with SL PRS;
a repetition factor associated with SL PRS;
an identifier for the SL PRS, and
an offset between the time in which the control signal is received and the time in which SL PRS will be transmitted or received/measured.

57. The method of claim 56 wherein the resource allocation in the time domain comprises one or more of: a starting symbol of SL PRS, a length of SL PRS, and/or end symbol of SL PRS, and
wherein the resource allocation in the frequency domain comprises one or more of: a starting PRB of SL PRS, an end PRB of SL PRS, and/or number of PRBs allocated for SL PRS.

58. The method of claim 56 wherein the control signaling is transmitted via a downlink control information, DCI.

59. The method of claim 58 wherein: the DCI is scrambled by an RNTI specific to triggering SL PRS, or
wherein: the DCI uses a DCI format specific to triggering SL PRS.

60. The method of claim 58 wherein: the DCI triggers at least one of: one SL PRS for transmission by the UE and a second SL PRS for reception/measurement by the UE.

61. The method of claim 58 wherein: the DCI contains one or more dedicated DCI fields that indicate at least one of the following dedicated DCI fields for the one SL PRS for transmission by the UE:
a first resource allocation in time domain;
a first resource allocation in frequency domain;
a first a comb factor associated with the one SL PRS;
a first repetition factor associated with the one SL PRS; and
a first identifier for the one SL PRS, and
wherein the DCI contains one or more dedicated DCI fields that indicate at least one of the following for the second SL PRS for reception/measurement by the UE:
a second resource allocation in time domain;
a second resource allocation in frequency domain;
a second a comb factor associated with the second SL PRS;
a second repetition factor associated with the second SL PRS; and
a second identifier for the second SL PRS.

62. The method of claim 58 wherein: when DCI with DCI format 3_0 is scrambled with SL-PRS-RNTI, the UE understands that the DCI format 3_0 contains one or more of the following fields:
one or more DCI fields for resource allocation in time—this field indicates one or more of starting symbol of SL PRS, length of SL PRS, and/or end symbol of SL PRS;
one or more DCI fields for resource allocation in frequency domain;
one or more fields can also indicate a comb factor of the SL PRS;
one DCI field indicating an offset between the time in which the DCI is received and the time in which SL PRS will be transmitted;
one or more fields indicating the number of repetitions for SL PRS; and
a SL PRS ID is indicated in one of the DCI fields.

63. The method of claim 58 wherein: the DCI includes a first ID of a first SL PRS a UE shall transmit and a second ID of a second SL PRS the UE shall receive.

64. The method of claim 63 wherein: the first ID and the second ID are provided by either a common DCI field or separate DCI fields in the same DCI.

65. The method of claim 56 wherein the control signaling is transmitted via a first stage sidelink control information, SCI, and a second stage SCI, and wherein the first stage SCI indicates via a field whether a 2nd stage SCI is triggered with SCI format 2-D.

66. A User Equipment for triggering Sidelink, SL, Positioning Reference Signal, PRS, the UE comprising processing circuitry and memory, the memory comprising instructions to cause the UE to:
receive control signaling for triggering SL PRS, where the control signaling includes one or more of:
a resource allocation in time domain;
a resource allocation in frequency domain;
a comb factor associated with SL PRS;
a repetition factor associated with SL PRS;
an identifier for the SL PRS, and
an offset between the time in which the control signal is received and the time in which SL PRS will be transmitted or received/measured.
